(19) United States
(12) Patent Application Publication
(10) Pub. No.: US 2006/0254125 A1
(43) Pub. Date: Nov. 16, 2006

(54) Silicone additives for compatabilizing fragrances with wax candles

(76) Inventors: Jo Anne Tully, Mahopac, NY (US); Suresh K. Rajaraman, Newburg, NY (US); Robert E. Ruckle, Brewster, NY (US)

Correspondence Address: GEAM - SILICONES - 60SI;IP LEGAL, ONE PLASTICS AVENUE, PITTSFIELD, MA, 01201-3697, US

(21) Appl. No.: 11/314,865

(22) Filed: Dec. 22, 2005

Related U.S. Application Data
(60) Provisional application No. 60/663,070, filed on Mar. 18, 2005.

(51) Int. Cl. C11C 5/00

(52) U.S. Cl. 44/275

(57) ABSTRACT

A composition suitable for use in candles comprising a wax; a fragrant compound; and a silicone whereby said silicone does not extinguish the candle when the candle is burned.

### CROSS REFERENCE TO RELATED APPLICATIONS

This application claims the benefit of U.S. Provisional Application Ser. No. 60/663070, filed Mar. 18, 2005.

### FIELD OF THE INVENTION

The present invention deals with candles and compositions suitable for incorporating fragrances and colors (dyes). More particularly the present invention deals with compatibilizing agents that tend to stabilize or compatibilize the dispersion of fragrant additives and colored dyes in the candle fuel material or that tend to prevent phase separation between the major and minor components of the candle.

### BACKGROUND OF THE INVENTION

The incorporation of fragrant oil(s) (perfumes) in candle wax is difficult to achieve in quantities sufficient to ensure the release of a suitable level of fragrance into the atmosphere for the end use customer. Incorporating high loadings of fragrances, particularly smaller, highly volatile perfumes, tends to result in migration and volatilization of the fragrance compound(s) being added during the candle making process. Migration of the fragrant compounds in the finished candle leads to weeping or bleeding of the fragrant oils at the surface during storage. The candle making industry, therefore, has long searched for an effective technique of manufacture or an additive, that would prevent or inhibit the separation of liquid oil additives and allows for incorporation of greater amounts of fragrance.

Several approaches to solving this problem have been disclosed. U.S. Pat. No. 6,775,6808 indicates the use of poly (alpha olefin) additives inhibit the separation of liquid oil additives from paraffin wax in paraffin objects such as candles. These materials primarily solve the problem of liquid additives such as liquid fragrances and liquid dyes separating or pooling in the top surfaces of candles after storage at room temperature.

U.S. Patent application 20030064336 discloses the use of a perfume-loaded porous inorganic carrier particles to produce intense and long-lasting fragrances. U.S. Patent application 20040068920 discloses a stabilized fragrance candle composition comprising wax, fragrance, and a stabilizing composition comprising an ultraviolet (UV) absorber and a hindered hydroxybenzoate.

### SUMMARY OF THE INVENTION

The present invention provides for a composition suitable for use in candles comprising:
a) a wax;
b) a fragrant compound; and
c) a silicone
   whereby said silicone does not extinguish the candle when the candle is burned. The present invention further provides for a method for preventing phase separation in a candle comprising a wax and a fragrant, said method comprising:
a) admixing
   i) a fragrant compound and
   ii) a silicone to form a mixture and
b) adding the mixture to a wax forming a candle precursor; and
c) making a candle using the candle precursor.

### DETAILED DESCRIPTION OF THE INVENTION

The object of the present invention relates to the inclusion of a silicone additive in a wax candle for increased compatibility of a liquid fragrance with the wax. The benefit of increased fragrance compatibility with the base wax is delivered by blending between 0.01 to about 25 percent by weight of the candle composition with the fragrance oil, more preferably between 0.1 and about 15 percent by weight. This mixture is incorporated into the candle wax composition with simple agitation when the wax is heated to it's melting temperature. The silicone additives improve the properties of the compatibility of the fragrance with the wax. Such additives render the wax more uniform in appearance than candles not treated with a fragrance and these silicone additives. In addition, candles treated with silicone additives with fragrances in wax compositions yield a flame that is comparable in height relative to the control itself, despite the well-known ability of many silicone compounds to act as flame retardants. The benefit of the present invention allows for the inclusion of higher levels of fragrance to be included in the candle without extinguishing the flame than those candle compositions that do not contain these additives.

The present invention includes the addition of silicone additives with an oil that is normally liquid at room temperature (such as to provide both a fragrance and appearance effect) in a wax candle composition. These silicone additives provide for better compatibility of the oil with wax, and at the same time produces a flame that is consistent in height and burn rate.

A common form of candle material is wax, which usually refers to a substance that is a plastic to brittle solid at ambient temperatures. Suitable waxes for forming the candle body include any known waxes, including but not limited to, paraffin wax, microcrystalline wax, beeswax, animal wax, vegetable wax, mineral wax, synthetic wax, and mixtures thereof. In addition to wax semi-solids (such as petrolatum), liquids, synthetic polymers and mixtures of synthetic polymers with one or more organic compounds may be used in a candle material or part of a candle material. Other typically used candle fuel source components such as hydrocarbon oil, stearic acid, may also be included in the candle material. The nature of the paraffin wax is not critical to the practice of this invention and may be any of the numerous commercial paraffin waxes available. While the invention has been exemplified with paraffin wax, it is expected that the method of this invention would find utility in compatabilizing oils with objects made with other waxes previously mentioned but not necessarily limited to.

Paraffin wax is considered as a petrolatum wax. Paraffin wax is typically macrocrystalline and brittle. The solidified wax composition, at a microscopic level, includes wax crystals packed against each other. Components of a wax composition, such as colorant, are typically trapped in the spaces between wax crystals. Fragrant molecules, however, are typically too small to be held in these inter crystal spaces. Consequently, the fragrant molecules often diffuse through the candle. This diffusion eventually brings the fragrance molecules to the surface, leading to weeping. The problem of weeping can be brought under control by the addition of chemicals that reduce the crystal size in the solidified candle wax. The smaller crystals pack tightly enough to trap the odorant inside their inter-crystal spaces.

With respect to the oil, the invention is expected to be effective with respect to most, if not all, fragrant oils typically added to waxes, where the fragrant oil is typically liquid at room temperature. While not generally preferred solid fragrant compounds should also be solubilized by the silicones used in the present invention. These liquid oils include, but are not necessarily limited to, essential oils, fragrances, and mineral oils. For example, cinnamon, vanillin, limonene, eugenol, spice, bayberry, pine fragrances, etc., are used as additives. In one non-limiting embodiment of the invention, the liquid fragrance oils are used in a total amount, based upon the total weight of the object, in proportions ranging from about 0 to about 50 wt %, preferably from about 0.5 to about 40 wt %, more preferably from about 1 to about 30 wt %, and most preferably from about 2 to about 20 wt %. Additionally, silicone materials that release a fragrant molecule by reaction, e.g. hydrolysis, may also be incorporated into the candle to provide fragrance. Examples of such fragrant silicon-containing molecules are to be found in U.S. Pat. Nos. 6,046,156; 6,075,111; 6,077,923; 6,083,901; 6,153,578; and 6,322,777.

Preferred silicone additives for use in the present invention include pendant polyalkylene oxide-modified polydialkylsiloxane having the formula:
MₐM_{b}M_{c}DₓD_{y}D_{z}T_{d}TₑT_{f}Q_{g};
where

Mₐ=R¹R²R³SiO_{1/2};

M_{b}=R⁴R⁵R⁶SiO_{1/2};

M_{c}=R⁷R⁸R⁹SiO_{1/2};

Dₓ=R¹⁰R¹¹SiO_{2/2};

D_{y}=R¹²R¹³SiO_{2/2};

D_{z}=R¹⁴R¹⁵SiO_{2/2}

T_{d}=R¹⁶SiO_{3/2};

Tₑ=R¹⁷SiO_{3/2};

T_{f}=R¹⁸SiO_{3/2};

Q_{g}=SiO_{4/2}

where R¹, R², R³, R⁵, R⁶, R⁸, R⁹, R¹⁰, R¹¹, R¹³, R¹⁵ and R¹⁶ are each independently selected from the group consisting of one to sixty carbon monovalent hydrocarbon radicals, alkyl aryl radicals, aryl radicals, alkyl phenol radicals;

R⁴, R⁷, R¹², R¹⁴, R¹⁷ and R¹⁸are each independently selected from the group radicals defined by the formula for Z;

where the subscripts a, b, c, x, y, z, d, e, f, and g are zero or positive integers for molecules subject to the following relationships:
(a+b+c) equals either (2+d+e+f+2g) or (d+e+f+2g)
0≦(x+y+z)≦100;
0≦(d+e+f)≦5;
0<g<3
with the requirement that b+y+e≧1;

and c+z+f>3, with Z having the formula:
BO(C₂H₄O)ₙ(C₃H₆O)ₚ(C₄H₈O)ᵣR¹⁸
where B is an alkylene radical of 2 to 4 carbons

R¹⁸ is a H, or a hydrocarbon radical of 1 to 4 carbons.

n, p and r are independently zero or positive subject to the requirement that:
4≦n+p+r≦100.

The silicone copolymers employed in the practice of the present invention can be prepared by general methods that are well know to those skilled in the art. For example, U.S. Pat. Nos. 3,280,160; 3,299,112; and 3,507,815 report the synthesis of copolymers of this type and demonstrate their utility as polyurethane foam stabilizers, as additives for personal care items, and as processing aids for textile applications. The copolymers can be prepared from allyl polyethers and polydimethylhydrosiloxanes and in the presence (U.S. Pat. Nos. 3,980,688 and 4,025,456) or absence (U.S. Pat. Nos. 4,847,398 and 5,191,103) of a solvent.

The candle of the current invention employ a wick, placed in the portion of the candle material comprising the fragrance and silicone additive dispersed throughout. The wick should be sufficiently thick so that it is not so small as to drown in a pool of molten wax as the candle burns, but not so excessively thick so as to cause the candle to smoke, drip excessively, and/or burn quickly. Typically, wicks are made of braided cotton in many different diameters, ranging from about 0.375 inches to about 3.75 inches.

All US patents referenced herein are specifically herewith incorporated by reference.

### EXAMPLE

84.5 g of Paraffin Wax (Yaley Enterprises) was melted in a double boiler/water bath. 15 g of Yaley French Vanilla fragrance and 0.5 g of the silicone or additive of Table 1 was blended together in a conventional manner. This mixture was then added to the molten wax until homogenous, and prior to being poured into a glass mold fitted with a wick near the center of the mold to form a candle. The candle was allowed to cool under ambient conditions.

The candles were tested for appearance and burn time. Burn time is the time it takes for the flame to consistently burn with a reduced height when compared to the control where the only difference is the absence of the silicone additive. Appearance includes all aspects of the candle to include uniformity of color, weeping, mottling, and craters. The scores are assigned based on visual observations and rated on a relative scale of 1 to 5 (5 is most desirable).

TABLE 1

| | |
|---|---|
| Silicone A | Linear ethylene oxide modified polydimethylsiloxane |
| Silicone B | First pendant ethylene oxide, propylene oxide modified |
| | polydimethylsiloxane |
| Silicone C | Second pendant ethylene oxide, propylene oxide |
| | modified Polydimethylsiloxane |
| Silicone D | First pendant propylene oxide modified |
| | polydimethylsiloxane |
| Silicone E | First pendant ethylene oxide modified |
| | polydimethylsiloxane |
| Silicone F | First alkyl modified polydimethylsiloxane |
| Silicone G | Aryl modified polydimethylsiloxane |
| Silicone H | Second alkyl modified polydimethylsiloxane |
| Silicone I | Second pendant propylene oxide modified |
| | polydimethylsiloxane |
| Silicone J | Linear propylene oxide modified polydimethylsiloxane |
| Silicone K | Third pendant propylene oxide modified |
| | polydimethylsiloxane |
| Silicone L | Fourth pendant propylene oxide modified |
| | polydimethylsiloxane Insert Silicone L after silicone K in |
| | table |
| Additive A | First polypropylene glycol |
| Additive B | Second propylene glycol |
| Additive C | Third propylene glycol |

TABLE 2

| EXAMPLE | APPEARANCE | BURN TIME |
|---|---|---|
| Paraffin Wax | 4.5 | 5+ |
| Paraffin Wax/Fragrance | 1 | 4.5 |
| Paraffin Wax/Fragrance/Silicone A | 1 | 2 |
| Paraffin Wax/Fragrance/Silicone B | 1 | 2 |
| Paraffin Wax/Fragrance/Silicone C | 1 | 2+ |
| Paraffin Wax/Fragrance/Silicone D | 4 | 5+ |
| Paraffin Wax/Fragrance/Silicone E | 2.5 | 2 |
| Paraffin Wax/Fragrance/Silicone F | 4 | 1 |
| Paraffin Wax/Fragrance/Silicone G | 2 | 1 |
| Paraffin Wax/Fragrance/Silicone H | 2 | 1.5 |
| Paraffin Wax/Fragrance/Silicone I | 3.5 | 4.5 |
| Paraffin Wax/Fragrance/Silicone J | 1.5 | 4.5 |
| Paraffin wax/Fragrance/Silicone K | 4 | 3.5 |
| Paraffin Wax/Fragrance/Silicone L | 4 | 4+ |
| Paraffin Wax/Fragrance/Additive A | 3 | 4 |
| Paraffin Wax/Fragrance/Additive B | 3 | 4.5 |
| Paraffin Wax/Fragrance/Additive C | 3 | 4+ |

The above examples reveal that fragranced candles fashioned with compositions according to this invention in particular pendant propylene oxide modified polydimethylsiloxane are improved with respect to appearance and compatabilization of the fragrance than those of other conventional compositions that do not contain such additives. Different silicone additives from those discussed and exemplified are also expected to be useful in the inventive method and products depending upon the exact combinations of liquid oils and organo-modified polydimethylsiloxane

It will be appreciated that it is difficult to specify with accuracy in advance the proportion of silicone additive to be used in a particular paraffin wax formulation to enhance oil compatibility without adversely effecting flame height. The best way to determine this proportion is by experimentation. The proportion of silicone additive in a particular paraffin wax formulation will depend upon a number of complex, interrelated factors including, but not necessarily limited to, the nature of the paraffin wax, the proportion and nature of the liquid oil additive, the nature of the silicone additive, but not necessarily limited to, the initial melt temperature and the rate of cooling, among other factors. Nevertheless, in an effort to give some indication of typical silicone additive concentration, in non-limiting embodiments the amount may range from about 0.1 wt % to 10 wt %, based on the total object weight, preferably from about 0.25 wt % to about 5 wt %.

Waxes

Below is a table of the types of waxes used in the candle industry. Usage level is up to 95% in fragranced candles and never less than 80-85%. Sometimes these are mixed to control the T_{g} of the candle which influences hardness, burn rate, melt pool temperature (and hence fragrance throw off), and other properties.

| Wax Type | Market Share |
|---|---|
| Paraffin | 70% |
| Beeswax | 15% |
| Candlelilla | 6% |
| Soy | 5% |
| Fischer-Tropsch | 3% |
| Microcrystalline wax | 1% |
| Tallow (not used) | 0% |

Fragrances

There are a myriad of molecules used as fragrances. These are typically blended and/or diluted with non-odiferous materials by the fragrance houses. Most are naturally occurring and isolated, only a few are synthesized. The fragrance is typically the highest unit/per costing product in the candle.

Use levels are up to 15%, as received, in highly fragranced premium candles. More commonly 5% is used in mass market candles to lower cost. The low end is probably 4%. We would hope that our additive would increase that usage amount as candle makers desire to use more, but are limited by their ability to disperse the fragrance with wax.

Below is a table of the most common chemicals used.

| Fragrance | Chemical Name | Family |
|---|---|---|
| Anethole | 1-methoxy-4-propenyl benzene | Benzenoid |
| Cinnamaldehyde | 3-phenyl-2-propenal | Benzenoid |
| Eugenol | 4-allyl-2-methoxyphenol | Benzenoid |
| Benzyl benzoate | Benzyl benzoate | Benzenoid |
| Benzyl Salicylate | Benzyl Salicylate | Benzenoid |
| Diphenyl Oxide | Diphenyl ether | Benzenoid |
| Benzyl acetate | Benzyl acetate | Benzenoid |
| α-Amyl Cinnamaldehyde | α-Amyl Cinnamaldehyde | Benzenoid |
| α-Hexyl cinnamaldehyde | α-Hexyl cinnamaldehyde | Benzenoid |
| p-anisaldehyde | 4-methoxybenzaldehyde | Benzenoid |
| Heliotropin (or piperonal | 3,4-methylenedioxybenzaldehyde | Benzenoid |
| Cyclamen aldehyde | p-isopropyl-α-methyldihydrocinnamaldehyde | Benzenoid |
| p-t-butyl-α-methyldihydrocinnamaldehyde | p-t-butyl-α-methyldihydrocinnamaldehyde | Benzenoid |
| Raspberry ketone | 1-[4-hydroxyphenyl]-3-butanone | Benzenoid |
| 2-phenylethyl alcohol (& | 2-phenylethyl alcohol (& esters) | Benzenoid |
| esters) | | |
| Benzaldehyde | Benzaldehyde | Benzenoid |
| Coumarin | Coumarin | Benzenoid |
| Isoamyl salicylate | Isoamyl salicylate | Benzenoid |
| Ethyl vanillin | 3-ethoxy-4-hydroxybenzaldehyde | Benzenoid |
| Vanillin | 3-methoxy-4-hydroxybenzaldehyde | Benzenoid |
| methyl salicylate | methyl salicylate | Benzenoid |
| Moskene | 1,1,3,3,5-pentamethyl-4,6-dinitroindan | Musk |
| Isochroman musk | 1,3,4,6,7,8-hexahydro-4,6,6,7,8,8- | Musk |
| | hexamethylcyclopenta-γ-2-benzopyran | |
| Musk xylol | 2,4,6-trinitro-5-t-butyl-m-xylene | Musk |
| Musk tibetine | 2,6-dinitro-3,4,5-trimethyl-t-butyl benzene | Musk |
| Musk ambrette | 2,6-dinitro-3-methoxy-4-t-butyl toluene | Musk |
| Musk ketone | 3,5-dinitro-2,6-dimethyl-4-t-butyl-acetophenone | Musk |
| Muscone | 3-methyl-cyclopentadecanone-1 | Musk |
| 5-acetyl-1,1,2,3,3,6- | 5-acetyl-1,1,2,3,3,6-hexamethylindan | Musk |
| hexamethylindan | | |
| 5-acetyl-1,1,2,6-tetramethyl- | 5-acetyl-1,1,2,6-tetramethyl-3-isopropylindan | Musk |
| 3-isopropylindan | | |
| Tetralin musk | 7-acetyl-1,1,3,4,4,6-hexamethyl-1,2,3,4-tetrahydronapthalene | Musk |
| Civetone | Cycloheptadecen-9-one | Musk |
| Cyclopentadecanolide | Cyclopentadecanolide | Musk |
| Cyclopentadecanone | Cyclopentadecanone | Musk |
| Indan musk 4-acetyl-1,1- | Indan musk 4-acetyl-1,1-dimethyl-6-t-butyl- | Musk |
| dimethyl-6-t-butyl-indan | indan | |
| Thylene brassylate | Thylene brassylate | Musk |
| Fixateur 404 | Fixateur 404 | Other |
| Benzyl Alcohol | Benzyl Alcohol | Other |
| Vernaldehyde | Vernaldehyde | Other |
| Leaf alcohol | cis-3-hexene-1-ol | Other |
| Maltol (& ethyl maltol) | 3-hydroxy-2-methyl-γ-pyrone | Other |
| Verdyl acetate | Verdyl acetate | Other |
| Jasmone, isojasmone & | Jasmone, isojasmone & dihydrojasmone | Other |
| dihydrojasmone | | |
| Sandela | Sandela | Other |
| Vernetex | p-t-butyl-cyclohexyl acetate | Other |
| 4-(4-hydroxy-4- | 4-(4-hydroxy-4-methylpentyl)-3-cyclohexene-10- | Other |
| methylpentyl)-3- | carboxaldehyde | |
| cyclohexene-10- | | |
| carboxaldehyde | | |

| Fragrance | Chemical Name | Family |
|---|---|---|
| Aliphatic aldehydes | Aliphatic aldehydes | Other |
| Fatty esters | Fatty esters | Other |
| Indoles, pyrazines, thiazoles | Indoles, pyrazines, thiazoles | Other |
| α-terpinol (& esters) | α-terpinol (& esters) | Terpenoid |
| Citronellal | Citronellal | Terpenoid |
| Citronellol (& esters) | Citronellol (& esters) | Terpenoid |
| Linalool (& esters) | Linalool (& esters) | Terpenoid |
| Citral or neral | Citral or neral | Terpenoid |
| Hydroxycitronellal | Hydroxycitronellal | Terpenoid |
| Geraniol or nerol (& esters) | Geraniol or nerol (& esters) | Terpenoid |
| Tetrahydrogeraniol | Tetrahydrogeraniol | Terpenoid |
| Dimethyl Octanol | 3,6-dimethyloctan-3-ol | Terpenoid |
| Ionones | Ionones | Terpenoid |
| Borneol/isoborneol (& | Borneol/isoborneol | Terpenoid |
| acetates) | (& acetates) | |
| Acetylated cedarwood | Cedryl acetate | Terpenoid |
| 1-Carvone | 1-Carvone | Terpenoid |
| 1-Menthol | 1-Menthol | Terpenoid |

Additives.

Stearic acid is typically used, at levels up to 5%. The purpose is to harden the wax and to improve the appearance of the candle.

Vybor, from Baker Petrolite, is used at up to 1% to harden the wax.

BHT and similar antioxidants are used at use levels sub 1%. Dyes are used at an unknown usage level.

MD_{7.0}D″_{3.0}M silicone additive where D″ is Me(SiO_{2/2})(CH₂)₃O(C₃H₆O)₁₂ n-C₄H₉ is effective at 0.5 wit. % with vanilla. EO, PO and EO/PO silicone polyether copolymers and alkyl, aryl, and aminoalkyl derivatives as well as polyester derivatives also work with fragrances.

### Example 2

Candle fragrances are a mixture of natural and synthetic materials which when incorporated into a candle can alter its appearance. This change in appearance can manifest itself as a change in color when compared to pure paraffin wax.

Additional candles were prepared in the manner previously detailed and once cooled were measured and horizontally cut into three sections. Each candle section (top, middle, and bottom) were further broken up into smaller pieces, and a representative 5 gram sample from each section was placed in separate aluminum weighing dishes that measured 6 cm. in diameter. The aluminum dishes containing the candle sections were placed in an oven, melted, cooled, and the resultant wax disk was measured for difference in color (Delta E) using the HunterLab Coloriquest and paraffin wax as the control. Lower Delta E means less change in color.

It is evident that the color, and therefore the fragrance of the candle containing the silicone additive is more uniform and evenly dispersed

COLOR DIFFERENCE MEASURMENTS (DELTA E) IN PARAFFIN
WAX CANDLE SECTIONS

| | Vanilla | Vanilla/Silicone Additive |
|---|---|---|
| top | 1.9 | 0.92 |
| middle | 1.51 | 0.95 |
| bottom | 0.89 | 1.04 |

across all 3 cross sections.

### Example 3

Syneresis (bleed) in candles if often caused by incompatibility of additives such as fragrance with the base wax of a candle. Candles were again prepared in the manner previously detailed and evaluated for candle bleed by wrapping them in preweighed absorbent tissue paper and subjecting them to accelerated aging via temperature cycling over a 24 hr. period. The tissue was reweighed and the weight gain is considered to be a result of migrating fragrance.

Results from this experiment indicate that the candle containing

SYNERESIS IN CANDLES
SUBSTRATE WEIGHT GAIN IN GRAMS

| | |
|---|---|
| Vanilla | 1.15 g |
| Vanilla/Silicone Additive | 0.84 g |

the silicone additive exhibit less bleed.

Having described the invention, we claim:

1. A composition suitable for use in candles comprising:
a. a wax;
b. a fragrant compound; and
c. a silicone
whereby said silicone does not extinguish the candle when the candle is burned.

2. A method for preventing phase separation in a candle comprising a wax and a fragrant, said method comprising:
a. admixing
i) a fragrant compound and
ii) a silicone
to form a mixture and
b. adding the mixture to a wax forming a candle precursor
c. making a candle using the candle precursor.

3. The composition of claim 1 where the silicone has the formula:
MₐM_{b}M_{c}DₓD_{y}D_{z}T_{d}TₑT_{f}Q_{g};
where
Mₐ=R¹R²R³SiO_{1/2};
M_{b}=R⁴R⁵R⁶SiO_{1/2};
M_{c}=R⁷R⁸R⁹SiO_{1/2};
Dₓ=R¹⁰R¹¹SiO_{2/2};
D_{y}=R¹²R¹³SiO_{2/2};
D_{z}=R¹⁴R¹⁵SiO_{2/2}
T_{d}=R¹⁶SiO_{3/2};
Tₑ=R¹⁷SiO_{3/2};
T_{f}=R¹⁸SiO_{3/2};
Q_{g}=SiO_{4/2}
where R¹, R², R³, R⁵, R⁶, R⁸, R⁹, R¹⁰, R¹¹, R¹³, R¹⁵ and R¹⁶ are each independently selected from the group consisting of one to sixty carbon monovalent hydrocarbon radicals, alkyl aryl radicals, aryl radicals, alkyl phenol radicals;
R⁴, R⁷, R¹², R¹⁴, R¹⁷ and R¹⁸ are each independently selected from the group radicals defined by the formula for Z;
where the subscripts a, b, c, x, y, z, d, e, f, and g are zero or positive integers for molecules subject to the following relationships:
(a+b+c) equals either (2+d+e+f+2g) or (d+e+f+2g)
0≦(x+y+z)≦100;
0≦(d+e+f)≦5;
0<g<3
with the requirement that b+y+e≧1;
and c+z+f>3, with Z having the formula:
BO(C₂H₄O)ₙ(C₃H₆O)ₚ(C₄H₈O)ᵣ R¹⁸
where B is an alkylene radical of 2 to 4 carbons
R¹⁸ is a H, or a hydrocarbon radical of 1 to 4 carbons. n, p and r are independently zero or positive subject to the requirement that:
4≦n+p+r≦100.
